(19) United States
(12) Patent Application Publication
(10) Pub. No.: US 2008/0205234 A1
(43) Pub. Date: Aug. 28, 2008

(54) Method and Apparatus for Recording on a Multi-Layer Disc

(75) Inventor: Pawel Andrzej Konieczny, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/995,011

(22) PCT Filed: Jul. 7, 2006
(86) PCT No.: PCT/IB06/52306

§ 371 Date: Jan. 8, 2008

(30) Foreign Application Priority Data
Jul. 13, 2005 (EP) 05106403.8

(51) Int. Cl. G11B 3/74

(52) U.S. Cl. 369/94

(57) ABSTRACT

A recording method, particularly suitable for use in a digital video-camera, is described according to which a digital signal (10), deriving from the encoding of an audio-video signal is temporarily stored in a buffer (11) and from there recorded on a dual layer DVD (12). The need for a layer jump occurs, independently from the current level of filling of the buffer, when a storage space associated to a first layer has been exhausted. In order to be able to store the digital signal in the buffer while the layer jump is accomplished, it is proposed to decrease the resolution in the encoding of the audio-video signal, so as to have the level in the buffer growing relatively slowly when the layer jump occurs.

The invention relates to a method of recording a digital signal on an information carrier comprising a first layer and a second layer, comprising the steps of:

storing the digital signal in a buffer at a storing rate,

recording the digital signal stored in the buffer on the first layer, until a storage space available on the first layer is filled, and

when the storage space available on the first layer is filled, suspending recording the digital signal on the first layer, effecting a layer jump, and resuming recording the digital signal on the second layer.

The invention further relates to an apparatus for recording a digital signal on an information carrier comprising a first layer and a second layer, comprising:

a buffer (11) for the storage of the digital signal at a storing rate (Rs), and

a recording unit (18), for recording the digital signal stored in the buffer on the first layer, until a storage space available on the first layer is filled, and when the storage space available on the first layer is filled, suspending recording the digital signal on the first layer, effecting a layer jump, and resuming recording the digital signal on the second layer.

A method of recording of the type indicated in the opening paragraph is known from EP0724256A2. This document describes the recording of information on an optical disc having a first layer and a second layer. The information, which is received from an external apparatus, is temporarily stored in a buffer and from there fetched to be recorded on the optical disc. The recording is effected on the first layer as long as there is storage space available, and on the second layer thereafter. An optimization operation of the tracking and focus control is required when a layer jump from the first layer to the second layer is effected, to optimize the tracking and focus control for the second layer.

However, when the layer jump is effected there are further operations that need to be carried out, like for example the calibration of one or more recording parameters, which usually require some recording trials. In order to be capable of accommodating the incoming information during all this time, a sufficiently large size of the buffer has to be selected.

It is an object of the present invention to provide a method of the type described in the opening paragraph, allowing for the use of a comparably smaller buffer.

It is a further object of the present invention to provide an apparatus of the type described in the opening paragraph in which a comparably smaller buffer is used.

According to the invention the first object is achieved by a method as claimed in claim 1. In other words what is done is to decrease the storing rate when the end of the first layer is approaching, so that during the interval of time comprised between the end of the recording on the first layer and the resumption of the recording on the second layer, herein referred to a layer jump non-recording layer, the level in the buffer grows comparably more slowly due to the decreased storing rate. In fact, the time required for the buffer to be filled up depends on the space available in the buffer and on the rate at which the buffer is filled up, which is equal to the storing rate minus the recording rate, i.e. the rate at which the digital signal stored in the buffer is recorded on the information carrier. During a layer jump the disc cannot be recorded, nor it can immediately following the layer jump, since the calibration of a number of control parameters in necessary before the recording can be resumed, thus the layer jump non-recording interval cannot end until said calibrations have been completed. During this non-recording interval the digital signal is stored in the buffer memory, and thus the buffer memory has to be large enough to accommodate the digital signal otherwise part of it may be lost with unacceptable consequences.

In view of the foregoing it can be understood that with a given time required for the calibrations and a given size of the buffer, the possibilities of a buffer overflow can be avoided or at least reduced by applying the method according to the invention.

In a particularly advantageous embodiment the storing rate can be decreased to a value that causes the buffer to be substantially empty at the moment when the first layer is completely recorded, as claimed in claim 2.

The time then available before the buffer is full, i.e. the time available for the layer jump and the consequent operations, is thus increased, because the buffer is substantially empty, and because the storing rate has a lower value.

The storing rate of the digital signal may 10 be influenced in various manners. If the digital signal 10 is transferred from another storage device to the buffer, then the storing rate Rs can be influenced by varying the rate of transfer from the other storage device.

Of more concern is the situation of a the digital signal which is generated as the result of the processing by processing means of an input signal received at an input of the processing means, where the receiving of the input signal is not under control, that is it cannot be slowed down, accelerated, or stopped. In an embodiment of the method according to the invention, the input signal may be another digital signal, the processing means being a compression block that compresses the other digital signal in the digital signal with a selectable compression rate: in this case it is possible to decrease the storing rate by increasing the compression rate, as claimed in claim 5.

In a different embodiment, the input signal may be an analogue signal, the processing means being an encoding block that converts the analogue signal in the digital signal with a selectable degree of resolution: in this case the storing rate can be varied by varying the degree of resolution, as claimed in claim 5. Of particular interest is the situation in which the analogue signal is a real-time audio-video signal, which recording cannot be stopped, the sanction being the loss of the audio-video signal during an interval of time.

Other advantageous embodiments are claimed in the other dependent claims.

As it will appear clear from the foregoing discussion, the further object is achieved according to the invention by an apparatus as claimed in claim 9. All the optional features of the method according to the invention defined in the dependent claims can be translated into corresponding optional features for the apparatus according to the invention.

These and other aspects of the method and apparatus according to the invention will be further elucidated and described with reference to the drawings. In the drawings:

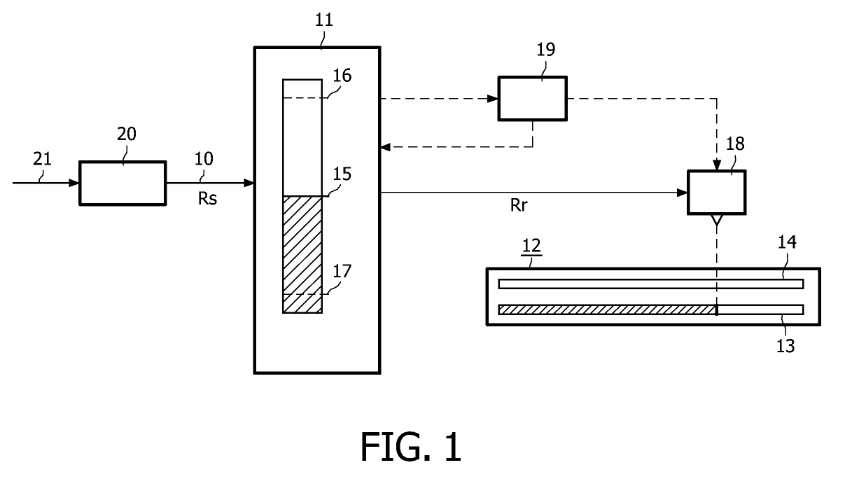

FIG. 1 shows a buffer where a digital signal to be recorded on a multi-layer information carrier is temporarily stored,

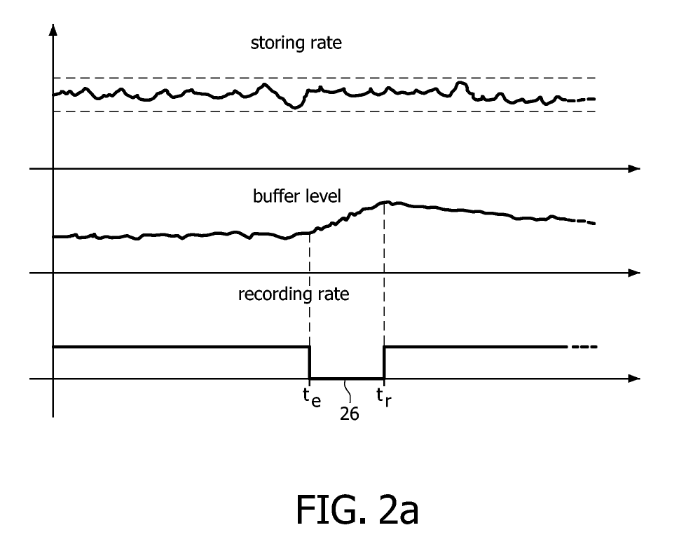

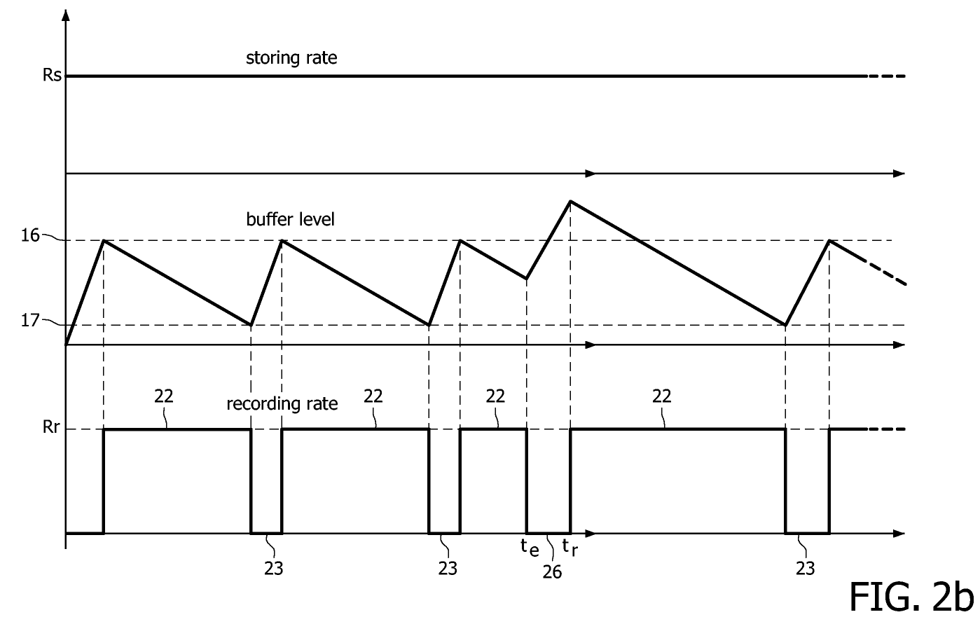

FIGS. 2a and 2b shows the level of filling in the buffer while recording a digital signal, including the occurrence of a layer jump, in two different situations,

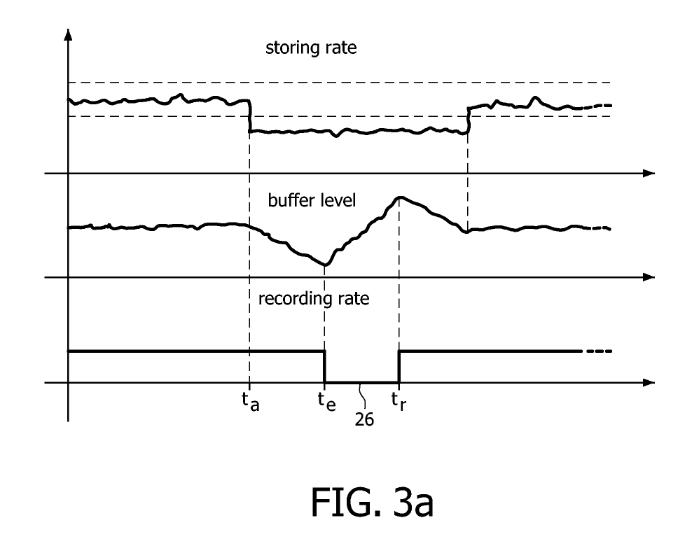

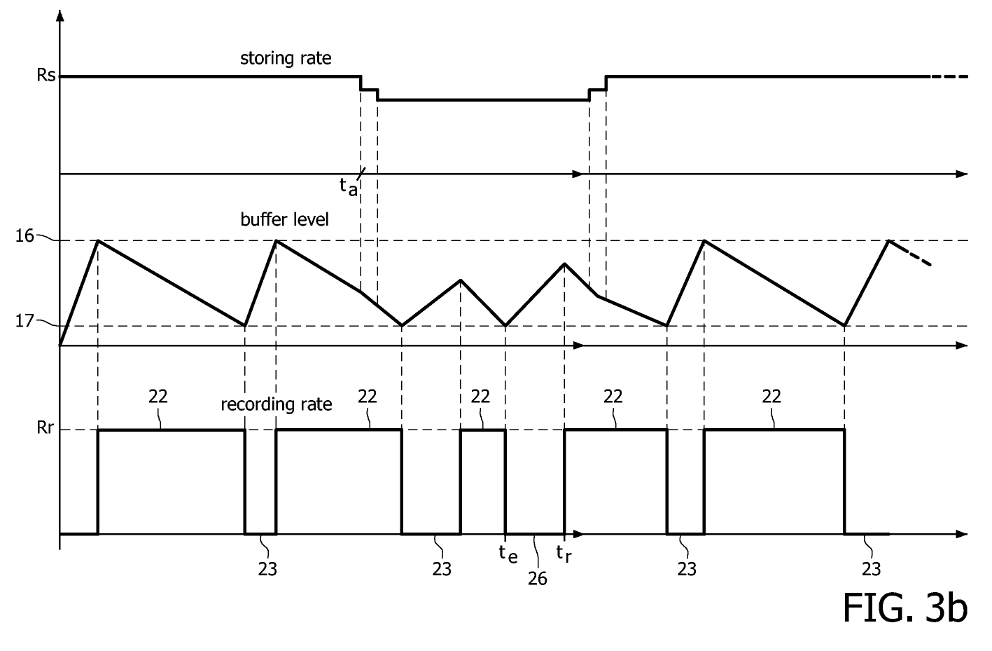

FIGS. 3a and 3b shows the level of filling in the buffer while recording a digital signal, including the occurrence of a layer jump, by applying the method according to the invention, in the two situations shown in FIGS. 2a and 2b respectively,

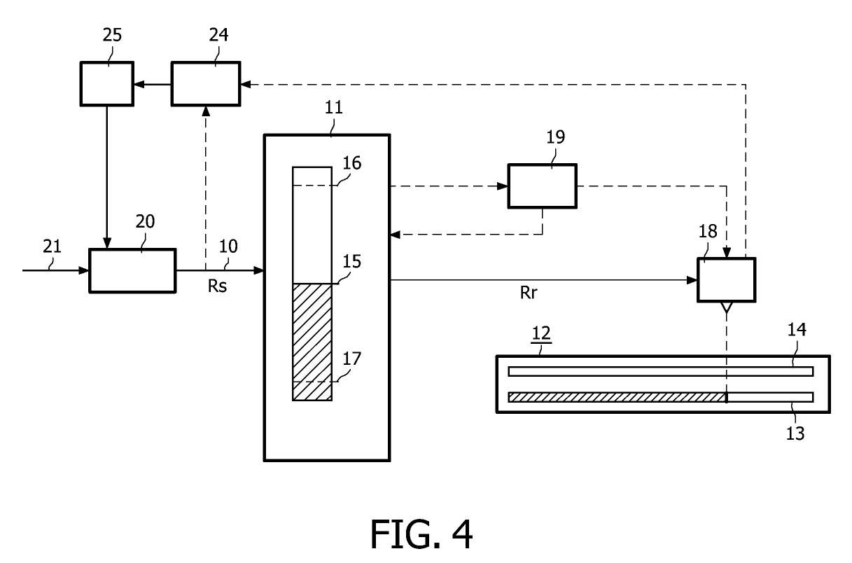

FIG. 4 shows an apparatus according to the invention.

FIG. 1 shows a buffer where a digital signal to be recorded on a multi-layer information carrier is temporarily stored.

The digital signal 10 is temporarily stored in the buffer 11 at a storing rate Rs, from where it is fetched to be recorded at a recording rate Rr on the multi-layer information carrier 12, which has a first layer 13 and a second layer 14. The digital signal 10 is in fact a digital representation of digital data. At a given moment the buffer is filled at a level 15 which may vary reflecting a difference between the storing rate Rs and the recording rate Rr.

The storing rate Rs may be constant or variable; if it is variable, it may be constrained variable, i.e. variable within a range around a nominal value, or fully variable; further, when varying between distinct values, it may be varying abruptly, in steps or continuously.

The recording can be activated/deactivated, and generally, when activated, the recording rate Rr is constant.

Generally the system has to be designed in such a way that Rr is equal to the average of Rs in a given interval of time, so that a buffer overflow or under flow can be prevented. More commonly Rr is higher in value than the storing rate Rs in average, and the recording can be repeatedly activated/deactivated: when the recording is not activated the level 15 of filling in the buffer 11 increases at a rate equal to the storing rate Rs; when the recording is activated the level 15 of filling in the buffer 11 decreases at a rate equal to Rr−Rs; the recording is controlled to be activated when the level 15 has increased up to a predetermined high level 16 and deactivated when the level 15 has decreased down to a predetermined low level 17. The predetermined high level 16 and the predetermined low level 17 may be close to a situation of buffer full and empty, respectively, however other choices are possible.

The predetermined high level 16 for example could be chosen as a level where 90% or more of the buffer is full, but not 100%, otherwise a buffer overflow could not be prevented anymore. The optimal determination of the predetermined high level 16 reflects design considerations like the time requested to activate the recording, the maximum storing rate and the buffer size. Similar considerations can be applied to the predetermined low level 17 as well, except for the fact that in some situations the condition of buffer empty can be perfectly acceptable or even desirable, so that fixing the predetermined low level 17 to 0% is in general possible.

The buffer 11 can be comprised in an apparatus for recording the multi-layer information carrier 12, the apparatus further comprising a recording unit 18, for recording the digital signal 10 stored in the buffer 11 on the first layer 13, until a storage space available on the first layer 13 is filled, and when the storage space available on the first layer 13 is filled, suspending the recording, effecting a layer jump, and resuming recording the digital signal 10 on the second layer 14. Further, the recording unit 18 can be activated/deactivated by a start/stop unit 19, upon reaching the predetermined high level 16/low level 17 in the buffer 11.

In an embodiment the digital signal 10 is output by processing means 20 as a result of processing an input signal 21, which input signal 21 may be itself another digital signal or an analogue signal, particularly a real-time audio video signal.

FIG. 2a shows the level of filling in the buffer while recording the digital signal in the situation in which the storing rate Rs is a constrained variable rate.

The first line represents the storing rate Rs having a constrained variable value. The second line represents the level 15 of filling in the buffer 11: apart from the initial value the level 15 of filling in the buffer 11 is the integral of the storing rate minus the recording rate Rs−Rr; consequently, the level 15 in the buffer 11 has some variations reflecting the variations in the storing rate.

The recording, indicated by the third line, takes place initially on the first layer 13, which is progressively filled until at a time te the storage space available therein is exhausted; then the recording is suspended, a layer jump takes place and the recording is resumed at a time tr on the second layer 14, not before control parameters have been adjusted for writing on the second layer 14 though. It is possible, and sometimes desirable, to effect a layer jump before the first layer is completely recorded: in this case a storage space available on the first layer must be intended as a subset of the recording area represented by the first layer.

During the layer jump non-recording interval 26, the digital signal 10 has to be stored in the buffer 11 and therefore the level 15 in the buffer 11 grows at a rate equal to Rs. If a situation of buffer overflow has to be avoided the buffer size has to be selected large enough for this purpose. The consequences of a buffer overflow may be particularly severe because part of the digital signal may be completely lost.

FIG. 2b shows the level of filling in the buffer while recording the digital signal in the situation in which the storing rate Rs is a constant rate and the recording takes place in recording intervals or packets.

The first line represents the storing rate Rs having a constant value. The second line represents the level 15 of filling in the buffer 11 which during normal operation varies between the predetermined high level 16 and the predetermined low level 17, indicated with respective dashed lines: the level 15 in the buffer 11 initially increases at the storing rate Rs, until the predetermined high level 16 is reached and the recording, shown by the third line, is activated. Consequently, the level 15 in the buffer 15 decreases at a rate equal to Rr−Rs, until the predetermined low level 17 is reached and the recording is deactivated, and so on, giving rise to a “saw tooth” shape. Therefore the recording, indicated by the third line, takes place in recording intervals 22, or “packets”, separated by non-recording intervals 23. The duration of the non-recording intervals 23 and the recording intervals 22 is determined by the values of the storing rate Rs, recording rate Rr, predetermined high level 16, predetermined low level 17 and by the size of the buffer 11.

It is clear what the impact is of a variation of the storing rate Rs: if the storing rate Rs increased the level 15 in the buffer 11 would increase faster during the non-recording intervals 23 and would decrease more slowly during the recording intervals 22, leading to shorter non-recording intervals 23 and longer recording intervals 22; vice versa, if the storing rate Rs decreased, then the level in the buffer 11 would increase more slowly during the non-recording interval 23 and would decrease faster during the recording intervals 22, leading to longer non-recording interval 23 and shorter recording intervals 22.

The recording takes place initially on the first layer 13, which is progressively filled until at the time te the storage space available therein is exhausted; then, completely independently of the level 15 in the buffet 11 at the time te, the recording is suspended, a layer jump takes place and the layer jump non-recording interval 26 takes place, during which the digital signal 10 has to be stored in the buffer 11.

The problem addressed by the invention is particularly severe in this situation because at the beginning of the layer jump non-recording interval 26, i.e. at the time te, the level 15 in the buffer 11 could be already as high as the predetermined high level 16. Thus in order to avoid the possibility of a buffer overflow, then the buffer size has to be selected large enough for this purpose, and the predetermined high level 16 sufficiently low, leading to a large and inefficiently used buffer.

FIG. 3a shows the level of filling in the buffer while recording the digital signal in the same situation discussed with reference to FIG. 2a by applying a method according to the invention. What is done differently from in FIG. 2a is that when approaching the end of the storage space available on the first layer at a time ta, i.e. in the condition of proximity to the storage space available on the first layer being filled, the storing rate Rs is decreased: this leads to having the buffer filled to a level lower than usual when the layer jump non-recording interval 26 begins, and also to a slower, less steep, increase of the level in the buffer the layer jump non-recording interval 26: both these effects concur to yield a longer time before a buffer overflow may occur, or similarly, to allow for a buffer of reduced size.

The initial value of the storing rate Rs can be restored after the layer jump non-recording interval 26, particularly when a sufficiently low level in the buffer has been restored.

The condition of proximity to the storage space available on the first layer being filled can be defined for example as the remaining storage space available on the first layer falling below a given threshold. Clearly the recording unit 18 can calculate the storage space available remaining at a given moment on the basis for example of a current recording address and the total storage space.

This method can be further enhanced if the storing rate Rs is decreased to a value calculated so that the layer jump non-recording interval 26 begins with the buffer 11 substantially empty, because also this concurs to provide a longer time before a buffer overflow may occur, or similarly, to allow for a buffer of reduced size. Generally, the earlier is ta, the smaller is the decrease in Rs which is required.

FIG. 3b shows the level of filling in the buffer while recording the digital signal in the same situation discussed with reference to FIG. 2b by applying the method according to the invention. What is done differently from in FIG. 2b is that when approaching the end of the storage space available on the first layer, i.e. in the condition of proximity to the storage space available on the first layer being filled, the storing rate Rs is decreased: this leads to a slower, less steep, increase of the level in the buffer the layer jump non-recording interval 26, and consequently to a longer time before a buffer overflow may occur, or similarly, to allow for a buffer of reduced size.

This method can be further enhanced if the last recording interval before the layer jump non-recording interval 26 is terminated with the buffer substantially empty, because also this concurs to provide a longer time before a buffer overflow may occur, or similarly, to allow for a buffer of reduced size.

This can be achieved by:

decreasing the storing rate Rs to a value so calculated that said last recording interval ends with the buffer substantially empty,

starting the recording interval beforehand, that is before the predetermined high level is reached, so that said last recording interval ends with the buffer substantially empty, or

a combination of the two measures above.

As it has been introduced above, the situation may be given in which the digital signal derives from the processing of an input signal, which input signal is generally not under control: that is the input signal cannot be slowed down, accelerated, or stopped.

In a particularly relevant embodiment the input signal is an analogue signal, for example a real-time audio/video signal, which recording cannot be stopped, the sanction being the loss of the audio/video signal during an interval of time. In this case the digital signal derives from the digitalization of the input signal and it is possible to decrease the rate at which the digital signal is generated for example by decreasing the sampling rate of the analogue signal and/or the resolution of the samples.

If the input signal is real-time audio/video signal the digital signal can be obtained by use of an MPEG encoder, which allows different levels of resolution: in this case the rate at which the digital signal is generated, sometimes referred to as bitrate, can be decreased by decreasing the level of resolution. In this case it is convenient to vary the level of resolution gradually, as shown in FIG. 3b, so as to make the change less abrupt and thus less perceptible.

According to some MPEG encoding methods it is possible to select a constrained variable bitrate instead of a constant bitrate. The constrained variable bitrate is a bitrate which can vary within a range around a nominal value, so as to optimize the visual perception.

All the considerations made above can be extended to the case of a storing rate Rs not constant. However, The fact that the instantaneous value of the storing rate Rs cannot be exactly known at a given moment in future introduces an element of uncertainty which makes it impossible to exactly calculate the required value for the storing rate Rs. This element of uncertainty can be dealt with for example in one of the following ways:

recalculating the storing rate Rs at successive moments, while approaching the end of the last portion,

allowing the recording interval to end with a level in the buffer different from zero with a suitable tolerance, or

switching temporarily to a constant storing rate Rs.

Once the recording interval has ended the adjustment of parameters necessary to record on the second layer can start. This includes one or more parameters defining the write strategy, i.e. the shape and amplitude of pulses used to write marks onto the recording layer, for which parameters a calibration procedure is necessary. The calibration may comprise a writing trial with different values, or sets of values, and a consequent determination of the best value, or set of values. This calibration can take up to 10-12 seconds.

The invention can be used for limiting the amount of memory required by the buffer 11, where the digital signal 10 has to be temporarily stored while said calibration is being performed.

Clearly, the method according to the invention can be exploited by a digital video-camera using a dual-layer recordable DVD as storage medium.

FIG. 4 shows an apparatus according to the invention. In addition to the parts already shown in FIG. 1, the apparatus comprises means for detecting 24 a proximity to the condition of the storage space available on the first layer being filled, while recording the signal on a first layer, and an adjustment unit 25, for decreasing the storing rate when said condition of proximity is detected, for example by varying a compression factor or a level of resolution in encoding, as explained above.

In an advantageous embodiment, the adjustment unit 25 is adapted for decreasing the storing rate Rs to a value such that the buffer 11 is substantially empty when the storage space available on the first layer 13 is filled.

It must be noted that the term “comprises/comprising” when used in this specification, including the claims, is taken to specify the presence of stated features, integers, steps or components, but does not exclude the presence or addition of one or more other features, integers, steps, components or groups thereof. It must also be noted that the word “a” or “an” preceding an element in a claim does not exclude the presence of a plurality of such elements. Moreover, any reference signs do not limit the scope of the claims; the invention can be implemented by means of both hardware and software, and several “means” may be represented by the same item of hardware. Furthermore, the invention resides in each and every novel feature or combination of features.

The invention can be summarized as follows. A recording method, particularly suitable for use in a digital video-camera, is described according to which a digital signal 10, deriving from the encoding of an audio-video signal is temporarily stored in a buffer 11 and from there recorded on a dual layer DVD 12. The need for a layer jump occurs, independently from the current level of filling of the buffer, when a storage space associated to a first layer has been exhausted. In order to be able to store the digital signal in the buffer while the layer jump is accomplished, it is proposed to decrease the resolution in the encoding of the audio-video signal, so as to have the level in the buffer growing relatively slowly when the layer jump occurs.

1. Method of recording a digital signal (10) on an information carrier (12) comprising a first layer (13) and a second layer (14), comprising the steps of:
storing the digital signal in a buffer (11) at a storing rate (Rs),
recording the digital signal stored in the buffer (11) on the first layer, until a storage space available on the first layer is filled, and
when the storage space available on the first layer is filled, suspending recording the digital signal on the first layer, effecting a layer jump, and resuming recording the digital signal on the second layer,
characterized by further comprising the following steps:
while recording the signal on the first layer, detecting a condition of proximity to the storage space available on the first layer being filled, and
decreasing the storing rate when said condition of proximity is detected.

2. Method as claimed in claim 1, characterized in that in decreasing the storing rate, the storing rate is decreased to a value such that the buffer is substantially empty when the storage space available on the first layer is filled.

3. Method as claimed in claim 1, characterized in that the recording is effected in recording intervals (22), the beginning of a recording interval being triggered by the buffer (11) having been filled up to a predetermined high level (16), and the end of the recording interval being triggered by the buffer having been emptied down to a predetermined low level (17).

4. Method as claimed in claim 1, characterized by further comprising the step of increasing the storing rate (Rs) after resuming recording the digital signal (10) on the second layer (14).

5. Method as claimed in claim 1, characterized by comprising the step of compressing an input signal (21) by a compression factor so as to obtain the digital signal (10), and wherein in decreasing the storing rate (Rs), the storing rate is decreased by increasing the compression factor.

6. Method as claimed in claim 1, characterized by comprising the step of encoding an input signal (21), in particular a real-time audio/video signal, with a level of resolution so as to obtain the digital signal (10), and wherein in decreasing the storing rate (Rs), the storing rate is decreased by decreasing the level of resolution.

7. Method as claimed in claim 6, characterized in that in decreasing the level of resolution, said level of resolution is decreased gradually.

8. Method as claimed in claim 6, characterized in that in encoding the input signal (21) an MPEG encoder is used.

9. Apparatus for recording a digital signal (10) on an information carrier (12) comprising a first layer (13) and a second layer (14), comprising:
a buffer (11) for the storage of the digital signal at a storing rate (Rs), and
a recording unit (18), for recording the digital signal stored in the buffer on the first layer, until a storage space available on the first layer is filled, and when the storage space available on the first layer is filled, suspending recording the digital signal on the first layer, effecting a layer jump, and resuming recording the digital signal on the second layer, characterized by further comprising:
means for detecting (24) a condition of proximity to the storage space available on the first layer being filled, while recording the signal on a first layer, and
an adjustment unit (25), for decreasing the storing rate when said condition of proximity is detected.

10. Apparatus as claimed in claim 9, characterized in that the adjustment unit (25) is adapted for decreasing the storing rate (Rs) to a value such that the buffer (11) is substantially empty when the storage space available on the first layer (13) is filled.
